(19) United States
(12) Patent Application Publication
(10) Pub. No.: US 2026/0101165 A1
(43) Pub. Date: Apr. 9, 2026

(54) METHOD AND APPARATUS FOR SUPPORTING EMERGENCY CALL IN A WIRELESS COMMUNICATION SYSTEM

(71) Applicant: Samsung Electronics Co., Ltd., Suwon-si (KR)

(72) Inventor: Kyungjoo SUH, Suwon-si (KR)

(21) Appl. No.: 19/347,209

(22) Filed: Oct. 1, 2025

(30) Foreign Application Priority Data
Oct. 4, 2024 (KR) 10-2024-0134701

(51) Int. Cl. H04W 4/90; H04L 65/1069; H04L 65/1073; H04L 65/1016

(52) U.S. Cl. CPC H04W 4/90; H04L 65/1069; H04L 65/1073; H04L 65/1016

(57) ABSTRACT

The disclosure relates to a fifth generation (5G) or sixth generation (6G) communication system for supporting a higher data transmission rate. According to an embodiment of the invention, a method performed by a user equipment (UE) in a wireless communication system comprises, transmitting, to an access and mobility management function (AMF) entity of network, a registration request message for an emergency call (E-call) service, receiving, from the AMF entity, a registration accept message for indicating that the network supports the E-call service over an internet protocol multimedia subsystem (IMS), transmitting, to a session management function (SMF) entity of the network, a protocol data unit (PDU) session establishment request message for a PDU session establishment, receiving, from the SMF, a PDU session establishment accept message, and transmitting, to a serving call session control function (S-CSCF) entity of the network, an IMS registration request message, wherein a dedicated uniform resource name (URN) of a public safety answering point (PSAP) to be accessed for the e-call service is provided based on the IMS registration request message.

METHOD AND APPARATUS FOR SUPPORTING EMERGENCY CALL IN A WIRELESS COMMUNICATION SYSTEM

### CROSS-REFERENCE TO RELATED APPLICATIONS

This application is based on and claims priority under 35 U.S.C. § 119(a) of a Korean patent application number 10-2024-0134701, filed on October 4, 2024, in the Korean Intellectual Property Office, the disclosure of which is incorporated by reference herein in its entirety.

### BACKGROUND

### 1. Field

The disclosure relates to a wireless communication system. More particularly, the disclosure relates to methods and apparatuses for supporting an emergency call in a wireless communication system.

### 2. Description of Related Art

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a “beyond 4G network” communication system or a “post long term evolution (LTE)" system. The 5G communication system specified by the 3rd generation partnership project (3GPP) is called a “new radio (NR) system.” The 5G communication system is considered to be implemented in ultrahigh frequency millimeter wave (mmWave) bands, (e.g., 60 gigahertz (GHz) bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques have been discussed in 5G communication systems and applied to the NR system. In addition, in the 5G communication system, technical development for system network improvement is under way based on evolved small cells, advanced small cells, cloud radio access networks (cloud radio access networks (RANs)), ultra-dense networks, device-to-device (D2D) communication, wireless backhaul, moving network, cooperative communication, coordinated multi-points (CoMPs), reception-end interference cancellation, and the like. In the 5G system, hybrid frequency shift keying (FSK) and quadrature amplitude modulation (QAM) modulation (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

5G mobile communication technologies define broad frequency bands such that high transmission rates and new services are possible, and can be implemented not only in “Sub 6GHz” bands such as 3.5GHz, but also in “Above 6GHz” bands referred to as mmWave including 28GHz and 39GHz. In addition, it has been considered to implement sixth generation (6G) mobile communication technologies (referred to as Beyond 5G systems) in terahertz (THz) bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and apparatuses for supporting an emergency call in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system comprises, transmitting, to an access and mobility management function (AMF) entity of network, a registration request message for an emergency call (E-call) service, receiving, from the AMF entity, a registration accept message for indicating that the network supports the E-call service over an internet protocol multimedia subsystem (IMS), transmitting, to a session management function (SMF) entity of the network, a protocol data unit (PDU) session establishment request message for a PDU session establishment, receiving, from the SMF, a PDU session establishment accept message, and transmitting, to a serving call session control function (S-CSCF) entity of the network, an IMS registration request message, wherein a dedicated uniform resource name (URN) of a public safety answering point (PSAP) to be accessed for the e-call service is provided based on the IMS registration request message.

In accordance with an aspect of the disclosure, a method performed by a base station in a wireless communication system comprises, receiving, from a user equipment (UE), a registration request message for an emergency call (E-call) service, transmitting, to the UE, a registration accept message for indicating that a network supports the E-call service over an internet protocol multimedia subsystem (IMS), receiving, from the UE, a protocol data unit (PDU) session establishment request message for a PDU session establishment, transmitting, to the UE, a PDU session establishment accept message, and receiving, from the UE, an IMS registration request message, wherein a dedicated uniform resource name (URN) of a public safety answering point (PSAP) to be accessed for the e-call service is provided based on the IMS registration request message.

In accordance with an aspect of the disclosure, a user equipment (UE) comprises at least one transceiver, at least one processor communicatively coupled to the at least one transceiver, and at least one memory, communicatively coupled to the at least one processor, storing instructions executable by the at least one processor individually or in any combination to cause the UE to, transmit, to an access and mobility management function (AMF) entity of network, a registration request message for an emergency call (E-call) service, receive, from the AMF entity, a registration accept message for indicating that the network supports the E-call service over an internet protocol multimedia subsystem (IMS), transmit, to a session management function (SMF) entity of the network, a protocol data unit (PDU) session establishment request message for a PDU session establishment, receive, from the SMF, a PDU session establishment accept message, and transmit, to a serving call session control function (S-CSCF) entity of the network, an IMS registration request message, wherein a dedicated uniform resource name (URN) of a public safety answering point (PSAP) to be accessed for the e-call service is provided based on the IMS registration request message.

In accordance with an aspect of the disclosure, a base station comprises at least one transceiver, at least one processor communicatively coupled to the at least one transceiver, and at least one memory, communicatively coupled to the at least one processor, storing instructions executable by the at least one processor individually or in any combination to cause the base station to, receive, from a user equipment (UE), a registration request message for an emergency call (E-call) service, transmit, to the UE, a registration accept message for indicating that a network supports the E-call service over an internet protocol multimedia subsystem (IMS), receive, from the UE, a protocol data unit (PDU) session establishment request message for a PDU session establishment, transmit, to the UE, a PDU session establishment accept message, and receive, from the UE, an IMS registration request message, wherein a dedicated uniform resource name (URN) of a public safety answering point (PSAP) to be accessed for the e-call service is provided based on the IMS registration request message.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an embodiment of a terminal and a network environment for supporting emergency communication in a 5G network according to an embodiment of the disclosure;

FIG. 2 is a flowchart illustrating a procedure for supporting emergency communication in a 5G network according to an embodiment of the disclosure;

FIG. 3 is a flowchart illustrating a procedure for supporting emergency communication in a 5G network according to an embodiment of the disclosure;

FIG. 4 illustrates a structure of a UE according to an embodiment of the disclosure; and

FIG. 5 illustrates a structure of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

It should be appreciated that the blocks in each flowchart and combinations of the flowchart may be performed by one or more computer programs which include instructions. The entirety of the one or more computer programs may be stored in a single memory device or the one or more computer programs may be divided with different portions stored in different multiple memory devices.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the "unit" may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more central processing units (CPUs) within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 3rd generation partnership project long term evolution (3GPP LTE) standards or terms and names modified based thereon will be used for the sake of descriptive convenience. However, the disclosure is not limited by the above terms and names, and may be applied in the same way to systems that conform other standards. In the disclosure, the term “evolved node B (eNB)” may be interchangeably used with the term “next generation node B (gNB)” for the sake of descriptive convenience. That is, a base station described as “eNB” may refer to “gNB.” In the disclosure, the term “terminal” may refer to not only mobile phones, narrowband internet of things (NB-IoT) devices, and sensors, but also various wireless communication devices.

That is, the following detailed description of embodiments of the disclosure is directed to communication standards specified by 3GPP, but based on determinations by those skilled in the art, the main idea of the disclosure may also be applied to other communication systems having similar technical backgrounds through some modifications without significantly departing from the scope of the disclosure.

In a 5G or NR system, an access and mobility management function (AMF), which is a management entity for managing mobility of a user equipment (UE), is separated from a session management function (SMF), which is an entity for managing a session. Accordingly, unlike in a 4G LTE communication system in which a mobility management entity (MME) has performed mobility management and session management together, in the 5G or NR system, entities performing mobility management and session management are separated, and thus a communication method and a communication management method between a UE and a network entity have been changed.

In the 5G or NR system, for non-3GPP access, mobility management is performed through the AMF via a non-3GPP inter-working function (N3IWF), and session management is performed through the SMF. In addition, security-related information, which is an important element in mobility management, is processed through the AMF.

As described above, in the 4G LTE system, the MME is responsible for both mobility management and session management. In the 5G or NR system, a non-standalone architecture for performing communication by using a network entity of the 4G LTE system together may be supported.

In the event of a car accident, emergency call (eCall) needs to be supported so that necessary information, such as the location of the car accident, a vehicle involved in the accident, and the type of accident is transmitted to a public-safety answering point or public-safety access point (PSAP). The PSAP provides a service that connects calls made from people or vehicles in emergency situations to emergency responders such as fire departments, police, or emergency medical services and ambulances.

The existing eCall service has been provided in a circuit switch (CS) domain, and in the case of 4G LTE or 5G NR, since a packet network is used, a requirement that the service be provided in a packet switched (PS) domain has been proposed by the European Committee for Standardization (CEN) (European Standards), and thus an eCall service is also provided in the packet switched (PS) domain.

However, in the case of an in-vehicle eCall system (IVS) that currently provides a packet-switched eCall service, there are a CEN compliant IVS and a 3rd generation partnership project (3GPP) compliant IVS, and the CEN compliant IVS and the 3GPP compliant IVS are configured to operate differently, and thus a rescue request from a vehicle/vehicle driver or passengers to the PSAP in an emergency situation cannot be properly made. In an embodiment, an eCall service provided on a packet switched (PS) network has a problem in that, unlike the eCall service provided on a CS-based network, information on an updated minimum set of data cannot be retrieved when a callback is made. In addition, in order to identify whether eCall operates normally, testing is required to be performed, and during testing, a minimum set of data is required to be transmitted. However, there is a problem in that even such a minimum set of data is not transmitted in the eCall service provided on the packet switched (PS) network. In addition, in the case of eCall, which is supported by the current PS network standard, there is a problem in which, when a failure code such as 4xx/6xx occurs, an eCall retry is performed, making it impossible to receive a callback from the PSAP.

Therefore, the disclosure describes a method capable of solving the above-described problems. In other words, the disclosure describes a method capable of (1) satisfying requirements of CEN even in a packet switched network, (2) enabling a minimum set of data to be transmitted properly, (3) enabling testing whether a minimum set of data is successfully transmitted, and (4) supporting a callback from a PSAP to an accident vehicle/vehicle driver and passengers, so as to enable smooth accident handling, including the rescue of human lives.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

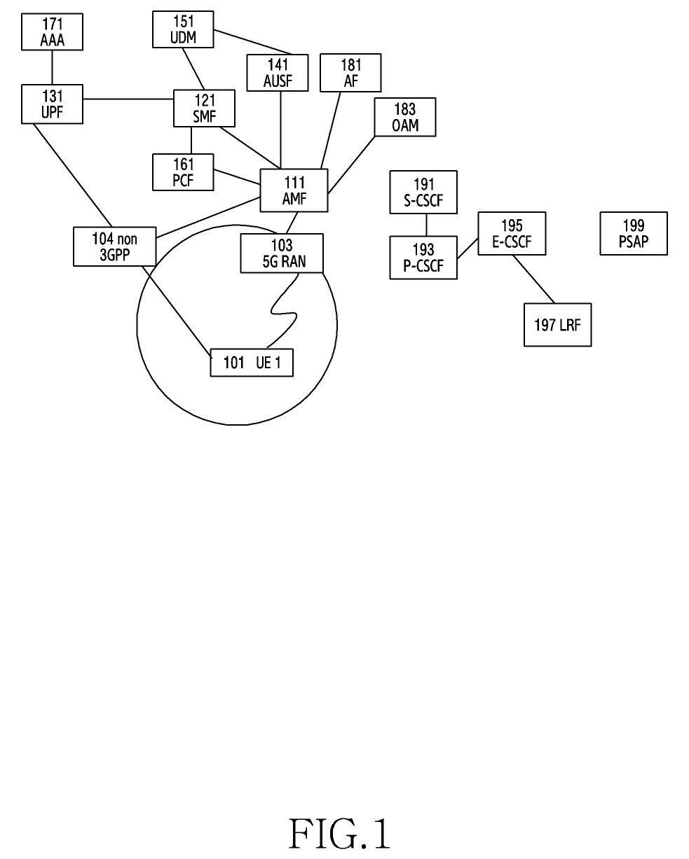

FIG. 1 illustrates an embodiment of a UE and a network environment for supporting emergency communication in a 5G network according to an embodiment of the disclosure.

Referring to FIG. 1, a 5G or NR core network may include network functions (NFs) such as a user plane function (UPF) 131, a session management function (SMF) 121, an access and mobility management function (AMF) 111, a 5G radio access network (RAN) 103, a user data management (UDM) 151, and a policy control function (PCF) 161, application function (AF) 181, operations, administration and maintenance (OAM) 183, location retrieval function (LRF) 197. In addition, for authentication of such entities, entities such as an authentication server function (AUSF) 141 and an authentication, authorization, and accounting (AAA) 171 may be included. A user equipment (UE) (terminal) may access a 5G core network through a base station (5G radio access network (RAN), base station (BS)) 103. Meanwhile, for a case where the UE communicates through non-3GPP access 104, an N3 interworking function (N3IWF) exists, and in a case where the UE communicates through non-3GPP access 104, session management is controlled by the UE, non-3GPP access 104, N3IWF, and SMF, and mobility management is controlled by the UE, non-3GPP access 104, N3IWF, and AMF.

In a 5G or NR system, entities performing mobility management and session management are separated into the AMF 111 and the SMF 121. Meanwhile, in the 5G or NR system, a stand-alone deployment structure in which communication is performed only by 5G or NR entities, and a non-stand-alone deployment structure in which 4G entities and 5G or NR entities are used together are being considered.

As shown in FIG. 1, in communication between the UE and the network, a deployment in which control is performed by an eNB and a 5G entity of the core network is used may be possible. In such a case, mobility management between the UE and the AMF and session management between the UE and the SMF may be performed at a non-access stratum (NAS) layer, which is layer 3.

The communication network on which the disclosure is based is assumed to be a 5G or 4G LTE network, but the same concept may be applied to other systems within a scope which may be understood by a person skilled in the art.

Referring to FIG. 1, an S-CSCF, a P-CSCF, an E-CSCF, and an LRF are entities for supporting internet protocol (IP) multimedia subsystem (IMS) calls and emergency calls over IMS. A call session control function (CSCF) is an entity for supporting IMS calls.

A serving CSCF (S-CSCF) manages session information of an IMS. Before processing session initiation protocol (SIP), the serving CSCF (S-CSCF) receives information on the UE or a user from an home subscriber server (HSS) and transmits an SIP packet to other servers. A proxy CSCF (P-CSCF) is an entity that the UE accesses in order to connect to the IMS, and receives an SIP request and establishes an optimal route. In addition, the proxy CSCF (P-CSCF) also performs authentication of the location of a user using a UE and an SIP packet. An emergency CSCF (E-CSCF) processes an emergency call. A location retrieval function (LRF) is an entity used to retrieve information on a user’s location.

In the case of a PSAP, in the event of a car accident, eCall is supported and necessary information, such as the location of the car accident, a vehicle involved in the accident, and the type of accident is transmitted to a public-safety answering point or public-safety access point (PSAP). The PSAP provides a service that connects calls made from people or vehicles in emergency situations to emergency responders such as fire departments, police, or emergency medical services and ambulances.

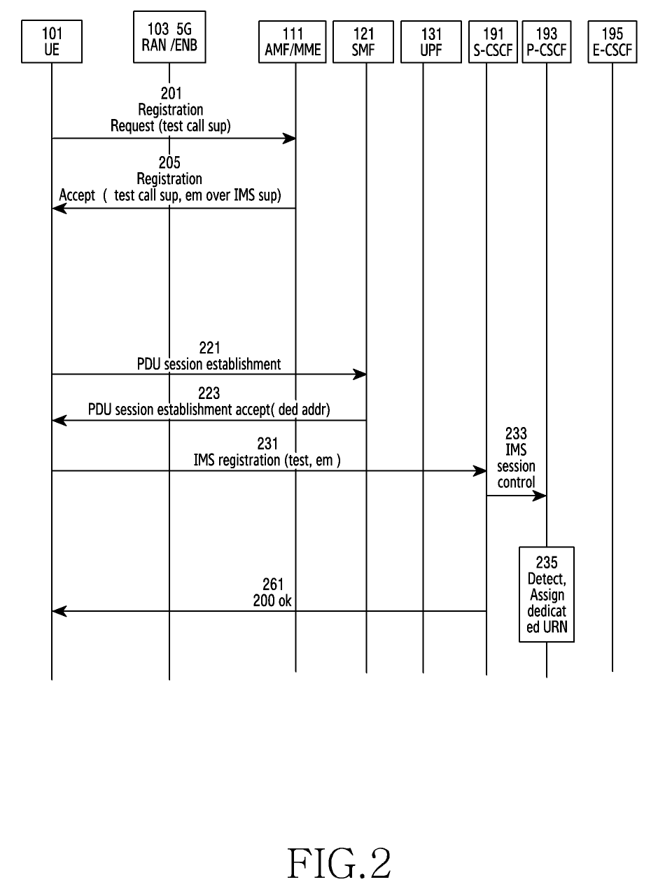

FIG. 2 is a flowchart illustrating a procedure for supporting emergency communication in a 5G network according to an embodiment of the disclosure.

Referring to FIG. 2, in operation 201, the UE 101 may transmit a registration request message to the AMF/MME 111 (201).

In this case, the UE 101 may transmit, to the network/AMF 111, an indicator, information, or information element indicating that the UE 101 is capable of supporting an e-call service.

In an embodiment, the UE 101 may transmit, to the network 111, an indicator, information, or information element indicating that the UE 101 is capable of supporting a test call.

In operation 205, the network/AMF 111 may transmit a registration accept message to the UE 101.

In this case, the network 111 may include the following information in the registration accept message and transmit the message.

1) In relation to supporting a test call, the network 111 may transmit information indicating that the network 111 is capable of supporting a test call.

2) The network 111 may transmit information indicating that the network 111 supports an e-call over IMS.

In operation 221, the UE 101 may transmit a protocol data unit (PDU) session establishment request message to the network 121.

In operation 223, the network 121 may transmit a PDU session establishment accept message to the UE 101.

In this case, information transmitted by the network/SMF 121 to the UE 101 may include the following information.

1) Information such as an IP address of a PSAP to which the UE 101 is required to connect for an e-call. The IP address of the PSAP may include information for indicating the corresponding PSAP. For example, a dedicated address may be used as information for indicating the corresponding PSAP.

In operation 231, the UE 101 may transmit an IMS registration request message for IMS registration to an S-CSCF 191.

The IMS registration request message may include the following information.

1) Information or an information element indicating that the UE 101 supports an e-call-related test call in an IMS environment.

In operation 233, the S-CSCF 191 may route an IMS registration message to a P-CSCF 193.

In operation 235, when the P-CSCF 193 receives the IMS registration message related to an e-call of the UE 101 from the S-CSCF 191, the P-CSCF 193 detects that a dedicated uniform resource name (URN) for the PSAP is required to be assigned, and assigns the dedicated URN for the PSAP.

In operation 261, the S-CSCF 191 transmits a 200ok response message to the UE 101.

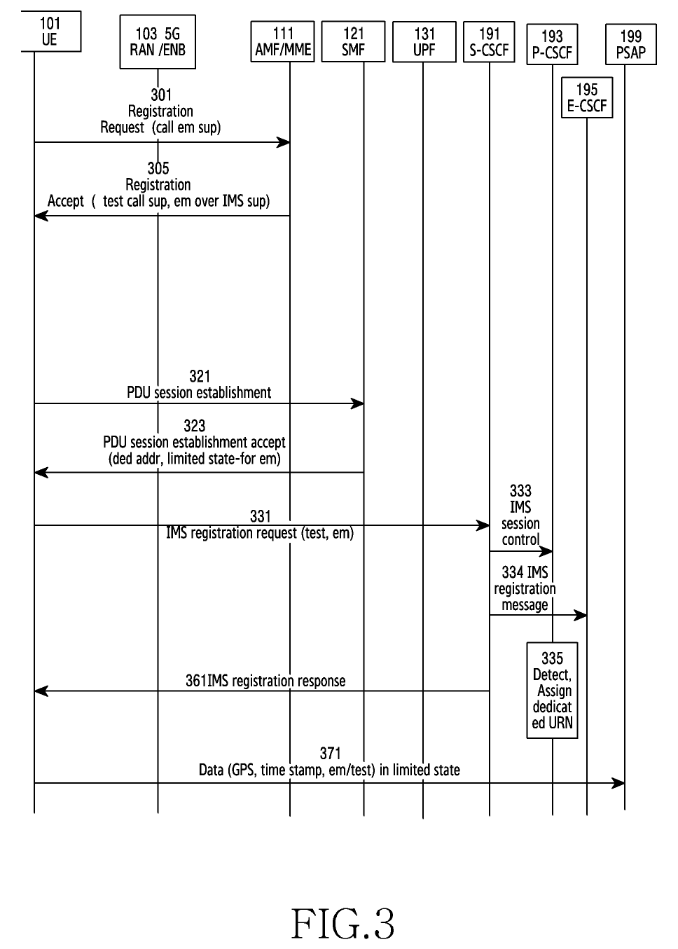

FIG. 3 is a flowchart illustrating a procedure for supporting emergency communication in a 5G network according to an embodiment of the disclosure.

Referring to FIG. 3, in operation 301, the UE 101 may transmit a registration request message to the AMF/MME 111.

1) In this case, the UE 101 may transmit, to the network/AMF 111, an indicator, information, or information element indicating that the UE 101 is capable of supporting an e-call service.

2) In an embodiment, the UE 101 may transmit, to the network 111, an indicator, information, or information element indicating that the UE 101 is capable of supporting a test call.

3) In this case, the UE 101 may transmit, to the network 111, information indicating that the corresponding call will be prioritized in providing a service, or information indicating that the corresponding call has a high priority. The network 111 having received such information may increase the priority of the corresponding call, and preferentially process the corresponding call.

4) Meanwhile, the UE 101 may transmit information indicating that the corresponding e-call is an emergency call.

5) Meanwhile, the UE 101 may transmit information such as an indicator and information indicating that the corresponding e-call is being executed in a limited service state.

In operation 305, the network/AMF 111 may transmit a registration accept message to the UE 101.

In this case, the network 111 may include the following information in the registration accept message and transmit the message.

1) Information indicating that the network 111 is capable of supporting a test call.

2) Information indicating that the network 111 supports an e-call over IMS.

3) In this case, the network 111 may transmit, to the UE 101, information indicating that the corresponding call will be prioritized in providing a service, or information indicating that the corresponding call will be processed with a high priority. The network 111 having transmitted such information may increase the priority of the corresponding UE 101 or the corresponding call, and preferentially process the corresponding call.

4) Meanwhile, the network 111 may transmit information such as an indicator and information indicating that the corresponding e-call will be executed in a limited service state. Therefore, the corresponding call will be processed in the limited service state.

In operation 321, the UE 101 may transmit a PDU session establishment request message to the network 121.

In operation 323, the network 121 may transmit a PDU session establishment accept message to the UE 101.

In this case, information transmitted by the network/SMF 121 to the UE 101 may include the following information.

1) Information such as an IP address of a PSAP to which the UE is required to connect for an e-call. The IP address of the PSAP may include information for indicating the corresponding PSAP. For example, a dedicated address may be used as information for indicating the corresponding PSAP.

2) The network 121 may provide information indicating that the UE 101 has established a PDU session in a limited service state.

3) Alternatively, in another embodiment, the network 121 may enable the UE 101 to establish a PDU session in the limited service state, and manage the PDU session in the limited service state.

In operation 331, the UE 101 may transmit an IMS registration request message for IMS registration to the S-CSCF 191.

The IMS registration request message may include the following information.

1) Information or an information element indicating that the UE 101 supports an e-call over IMS over in relation to an e-call in an IMS environment.

In operation 333, the S-CSCF 191 may route an IMS registration message to the P-CSCF 193.

In operation 334, the P-CSCF 193 may route IMS registration to an E-CSCF 195.

In operation 335, when the P-CSCF 193 receives the IMS registration message related to an e-call of the UE 101, the P-CSCF 193 may detect that a dedicated URN for the PSAP is required to be assigned, and may assign the dedicated URN for the PSAP.

In operation 361, the UE 101 may receive the IMS registration response message.

In operation 371, the UE 101 may transmit the following information to a PSAP 199.

1) Information such as UE 101-related data and incident-related data. The information such as the UE 101-related data and the incident-related data may include location information of the UE or GPS information of the UE.

2) Information on a relevant time stamp value in the event of an accident/incident.

3) Type, indicator, or classification information for distinguishing whether data transmitted by the UE 101 is data for an emergency call or data for a test call.

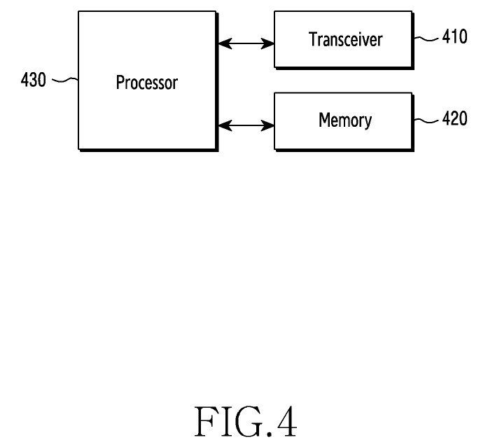

FIG. 4 illustrates a structure of a UE according to an embodiment of the disclosure.

Referring to FIG. 4, a UE of the disclosure may include a transceiver 410, memory 420, and a processor 430. The processor 430, the transceiver 410, and the memory 420 of the UE may operate according to the above-described communication methods of the UE. Components of the UE are not limited to the above-described example. For example, the UE may include a larger or smaller number of components than the above-described components. In addition, the processor 430, the transceiver 410, and the memory 420 may be implemented in the form of a single chip.

The transceiver 410 refers to a UE receiver and a UE transmitter as a whole, and may transmit/receive signals with base stations or network entities. The signals transmitted/received with base stations may include control information and data. To this end, the transceiver 410 may include an RF transmitter configured to up-convert and amplify the frequency of transmitted signals, an RF receiver configured to low-noise-amplify received signals and down-convert the frequency thereof, and the like. However, this is only an embodiment of the transceiver 410, and the components of the transceiver 410 are not limited to the RF transmitter and the RF receiver.

Also, the transceiver 410 may include wired/wireless transceivers, and may include various components for transmitting/receiving signals.

In addition, the transceiver 410 may receive signals through a radio channel, output the same to the processor 430, and transmit signals output from the processor 430 through the radio channel.

Furthermore, the transceiver 410 may receive communication signals, output same to a processor, and transmit signals output from the processor to a network entity through a wired/wireless network.

The memory 420 may store programs and data necessary for operations of the UE. In addition, the memory 420 may store control information or data included in signals acquired by the UE. The memory 420 may include storage media such as read only memory (ROM), random access memory (RAM), a hard disk, a compact disc-ROM (CD-ROM), and a digital versatile disc (DVD), or a combination of storage media.

The processor 430 may control a series of processes so that the UE can operate according to the above-described embodiments. The processor 430 may include at least one processor. For example, the processor 430 may include a communication processor (CP) which performs control for communication and an application processor (AP) which controls upper layers such as application programs.

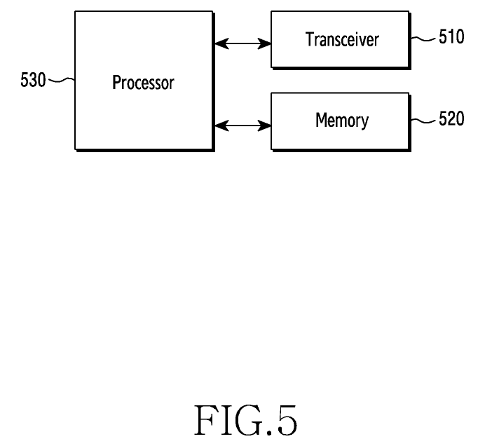

FIG. 5 illustrates a structure of a network entity according to an embodiment of the disclosure.

Referring to FIG. 5, a network entity of the disclosure may include a transceiver 510, memory 520, and a processor 530. The processor 530, the transceiver 510, and the memory 520 of the network entity may operate according to the above-described communication methods of the network entity. However, components of the network entity are not limited to the above-described example. For example, the network entity may include a larger or smaller number of components than the above-described components. In addition, the processor 530, the transceiver 510, and the memory 520 may be implemented in the form of a single chip. The network entity may include network functions (NFs), such as an access and mobility management function (AMF), a session management function (SMF), a policy and charging function (PCF), a network exposure function (NEF), a unified data management (UDM), and a user plane function (UPF), as described above. Also, the network entity may include a base station.

The transceiver 510 refers to a network entity receiver and a network entity transmitter as a whole, and may transmit/receive signals with UEs or other network entities. The transmitted/received signals may include control information and data. To this end, the transceiver 510 may include an RF transmitter configured to up-convert and amplify the frequency of transmitted signals, an RF receiver configured to low-noise-amplify received signals and down-convert the frequency thereof, and the like. However, this is only an embodiment of the transceiver 510, and the components of the transceiver 510 are not limited to the RF transmitter and the RF receiver. The transceiver 510 may include wired/wireless transceivers, and may include various components for transmitting/receiving signals.

In addition, the transceiver 510 may receive signals through a communication channel (e.g., a radio channel), output the same to the processor 530, and transmit signals output from the processor 530 through the communication channel.

Furthermore, the transceiver 510 may receive communication signals, output same to a processor, and transmit signals output from the processor to UEs or network entities through a wired/wireless network.

The memory 520 may store programs and data necessary for operations of the network entity. In addition, the memory 520 may store control information or data included in signals acquired by the network entity. The memory 520 may include storage media such as a ROM, a RAM, a hard disk, a CD-ROM, and a DVD, or a combination of storage media.

The processor 530 may control a series of processes so that the network entity can operate according to the above-described embodiments of the disclosure. The processor 530 may include at least one processor. Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to an access and mobility management function (AMF) entity of network, a registration request message for an emergency call (E-call) service;
receiving, from the AMF entity, a registration accept message for indicating that the network supports the E-call service over an internet protocol multimedia subsystem (IMS);
transmitting, to a session management function (SMF) entity of the network, a protocol data unit (PDU) session establishment request message for a PDU session establishment;
receiving, from the SMF, a PDU session establishment accept message; and
transmitting, to a serving call session control function (S-CSCF) entity of the network, an IMS registration request message,
wherein a dedicated uniform resource name (URN) of a public safety answering point (PSAP) to be accessed for the e-call service is provided based on the IMS registration request message.

2. The method of claim 1, wherein the PDU session establishment accept message includes information for indicating that the PDU session is established in a limited service state.

3. The method of claim 1, wherein the registration accept message further includes information for indicating that the network supports a service for a test call.

4. The method of claim 1, further comprising:
transmitting, to the PSAP, data for an E-call,
wherein the data for the E-call includes information on a location of the UE, a global positioning system (GPS) data of the UE, a time stamp of an emergency accident, and an indicator for indicating a type of the E-call.

5. The method of claim 4, wherein the type of the E-call includes a first type for the emergency accident and a second type for a test call.

6. A method performed by a base station in a wireless communication system, the method comprising:
receiving, from a user equipment (UE), a registration request message for an emergency call (E-call) service;
transmitting, to the UE, a registration accept message for indicating that a network supports the E-call service over an internet protocol multimedia subsystem (IMS);
receiving, from the UE, a protocol data unit (PDU) session establishment request message for a PDU session establishment;
transmitting, to the UE, a PDU session establishment accept message; and
receiving, from the UE, an IMS registration request message,
wherein a dedicated uniform resource name (URN) of a public safety answering point (PSAP) to be accessed for the e-call service is provided based on the IMS registration request message.

7. The method of claim 6, wherein the PDU session establishment accept message includes information for indicating that the PDU session is established in a limited service state.

8. The method of claim 6, wherein the registration accept message further includes information for indicating that the network supports a service for a test call.

9. The method of claim 6, further comprising:
receiving, from the UE, data for an E-call,
wherein the data for the E-call includes information on a location of the UE, a global positioning system (GPS) data of the UE, a time stamp of an emergency accident, and an indicator for indicating a type of the E-call.

10. The method of claim 9, wherein the type of the E-call includes a first type for the emergency accident and a second type for a test call.

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
transmit, to an access and mobility management function (AMF) entity of network, a registration request message for an emergency call (E-call) service;
receive, from the AMF entity, a registration accept message for indicating that the network supports the E-call service over an internet protocol multimedia subsystem (IMS);
transmit, to a session management function (SMF) entity of the network, a protocol data unit (PDU) session establishment request message for a PDU session establishment;
receive, from the SMF, a PDU session establishment accept message; and
transmit, to a serving call session control function (S-CSCF) entity of the network, an IMS registration request message,
wherein a dedicated uniform resource name (URN) of a public safety answering point (PSAP) to be accessed for the e-call service is provided based on the IMS registration request message.

12. The UE of claim 11, wherein the PDU session establishment accept message includes information for indicating that the PDU session is established in a limited service state.

13. The UE of claim 11, wherein the registration accept message further includes information for indicating that the network supports a service for a test call.

14. The UE of claim 11,
wherein the instructions further cause the UE to:
transmit, to the PSAP, data for an E-call, and
wherein the data for the E-call includes information on a location of the UE, a global positioning system (GPS) data of the UE, a time stamp of an emergency accident, and an indicator for indicating a type of the E-call.

15. The UE of claim 14, wherein the type of the E-call includes a first type for the emergency accident and a second type for a test call.

16. A base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
receive, from a user equipment (UE), a registration request message for an emergency call (E-call) service;
transmit, to the UE, a registration accept message for indicating that a network supports the E-call service over an internet protocol multimedia subsystem (IMS);
receive, from the UE, a protocol data unit (PDU) session establishment request message for a PDU session establishment;
transmit, to the UE, a PDU session establishment accept message; and
receive, from the UE, an IMS registration request message,
wherein a dedicated uniform resource name (URN) of a public safety answering point (PSAP) to be accessed for the e-call service is provided based on the IMS registration request message.

17. The base station of claim 16, wherein the PDU session establishment accept message includes information for indicating that the PDU session is established in a limited service state.

18. The base station of claim 16, wherein the registration accept message further includes information for indicating that the network supports a service for a test call.

19. The base station of claim 16, wherein the instructions further cause the base station to:
receive, from the UE, data for an E-call,
wherein the data for the E-call includes information on a location of the UE, a global positioning system (GPS) data of the UE, a time stamp of an emergency accident, and an indicator for indicating a type of the E-call.

20. The base station of claim 19, wherein the type of the E-call includes a first type for the emergency accident and a second type for a test call.
